(19) United States
(12) Patent Application Publication
(10) Pub. No.: US 2009/0283597 A1
(43) Pub. Date: Nov. 19, 2009

(54) Electronic Voting Device, and Corresponding Method and Computer Program Product

(75) Inventors: Bernard Charles, Saint Ouen L'Amoune (FR); Jean-Marc Voelckel, Mayrepas (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Compagnie Industrielle et Financiere D'Ingenierie, "Ingencio", Neuilly Sur Seine (FR)

(21) Appl. No.: 12/467,793

(22) Filed: May 18, 2009

(30) Foreign Application Priority Data
May 16, 2008 (FR) 0853209

(51) Int. Cl. G07C 13/00

(52) U.S. Cl. 235/386

(57) ABSTRACT

A secure electronic voting device includes a reading device for reading electronic voting ballots carrying an item of voting information; an insertion device inserting a voting ballot into the reading device and preventing withdrawal of the ballot; a checking device checking validity of said voting ballot, issuing a signal transferring the voting ballot to a ballot box, after the item of voting information has been taken into account, when the voting ballot and/or the voting conditions are considered valid; a processor processing the item of voting information read by the reading device; a transfer device automatically transferring the voting ballot, after receipt of said signal confirming it has been taken into account and without human intervention, to the ballot box, allowing double counting of the voting information, one using data read by the reading device, and another performed in a deferred manner, by reprocessing voting ballots kept in the ballot box.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of electronic voting. More precisely, the disclosure concerns techniques using electronic voting ballots, for example in the form of smart cards, capable of being read by adapted electronic readers.

### BACKGROUND OF THE DISCLOSURE

Many voting machines have appeared during the last ten years or so.

These machines have in particular an economic advantage for election organizers, in particular local authorities, since they require much lesser human resources than the organization of traditional elections.

They also increase the reliability of voting operations, by limiting manipulations, possibly malicious, of voting ballots and avoiding or reducing counting errors.

Moreover, these solutions allow much faster counting of the votes.

In practice, even though they offer many advantages, voting machines are little used, however, and with a greater or lesser degree of success.

This is because existing voting machines generally comprise a conventional smart card reader, into which the elector inserts his card (electronic voting ballot) which he has previously configured, or programmed, according to his voting intentions. The reader reads the voting data on the card, and then returns the read card, in order to move on to the next vote. Often, provision is made for the read card to then be reinitialized, so that it can be used by another user. This approach makes it possible to limit the number of cards necessary for carrying out an election.

This operating method does not however correspond to the usual practices as regards voting, and therefore disconcerts the majority of electors and assessors. This therefore leads to reluctance in using such types of machine.

Furthermore, and although the voting machines in use are subject to a strict check before approval, many people are worried about the risks of a fault in such systems, perhaps even of fraud, and in addition criticize the opaqueness of the checks possible. This is because, unlike the traditional way of voting, the electronic voting machines in use do not allow an elector to monitor the voting operations with his own eyes and therefore to make sure that the election is taking place correctly. In particular, the counting or recounting of votes is beyond a check by the electors.

### SUMMARY

An aspect of the disclosure relates to a secure electronic voting device, comprising means for reading electronic voting ballots carrying at least one item of voting information previously written by an elector using appropriate writing means, comprising:
means for inserting a voting ballot into said reading means, cooperating with means for preventing withdrawal of said ballot;
means for checking validity of the voting ballot, issuing a signal for transferring said voting ballot to a secure ballot box, after the at least one item of voting information has been taken into account, when said voting ballot and/or the voting conditions are considered valid;
means for processing the at least one item voting information read by said reading means; and
means for automatically transferring said voting ballot, after receipt of the signal confirming the voting ballot has been taken into account and without human intervention, to the secure ballot box,
so as to allow double counting of said item of voting information, one using the item of information read by said reading means, and another in a deferred manner, by reprocessing the voting ballots kept in said secure ballot box.

Thus, an exemplary aspect of the disclosure offers many advantages, compared with the prior art, in terms of efficiency and security:
the ballot box does not have to be opened before the recounting, if any, and the risk of addition or removal of voting ballots is eliminated;
the device makes it possible to have two sources, which allows comparisons if necessary;
it also makes it possible to remotely transfer the information read, and keep it securely;
it is possible to have the result of the vote as soon as the polling stations close, whilst retaining the possibility of checking (which is even improved, since the ballot box has not been opened);
statistics can be generated in real time or deferred, in particular according to a time stamp;
the device makes it possible to choose to eliminate null and void or blank ballots.

Said device is implemented so as to protect the voting ballot from any possible access while it is being processed and/or kept. This relates to protection against any manipulation of the voting ballot (the device comprises for example a hermetic cover). In an exemplary embodiment of the disclosure, adapted to the use of voting ballots provided with an RFID chip for example, said device is also provided for protecting the voting ballots from any remote access. For example, it can be made from a material forming an electromagnetic barrier and/or emit jamming signals.

Thus, in an exemplary embodiment of the disclosure, said checking means take account of at least one item of information for identification and/or authentication of an elector and/or at least one assessor responsible for said voting ballot.

For example, said checking means comprise at least one of the items belonging to the group comprising:
means for obtaining at least one item of biometric information;
means for reading at least one identification and/or authentication data medium;
a keypad for entering an identification and/or authentication code;
means for recording and/or voice recognition of at least one keyword;
means for recording and/or recognizing a handwritten signature.

Said means for checking the validity of the voting ballot can also comprise means of verifying the right to vote of said elector.

For example, they comprise a means for reading an elector card, a means for verifying the membership of said elector to a set of expected electors and/or a means for verifying the earlier participation of said elector in the same vote. Thus, use of the device can for example be restricted to the electors recorded on this device.

According to a particular embodiment, where the means for verifying the right to vote comprise at least one item of identification information for said elector, the device can store locally, in a secure memory, at least one item of identification information relating to each elector for whom it is counting the vote in order to make sure, at the time of insertion of a new voting ballot, that the associated elector has not already voted.

In another embodiment, the device can communicate at least one item of identification information relating to each elector who has voted to a remote server and/or interrogate this server in order to determine the right to vote of an elector.

According to an embodiment of the disclosure, said checking means can also verify the validity of the item or items of voting information present on said voting ballot, with respect to at least one predefined validity criterion.

This can be, for example, the success and/or failure of the reading of said voting ballot by said reading means and/or the comparison of at least one item of initialization or time stamp data stored on said voting ballot with at least one characteristic of the election configured at the level of said device.

Thus, said checking means can restrict for example the validity of voting ballots according to criteria such as the district of the elector, the polling station, the polling date, or a reference and/or an approval of said writing means.

Said checking means can also comprise means for checking the completeness of the voting information.

It can thus, for example, invalidate voting ballots not comprising voting information, so as to reject “blank” votes.

Moreover, in certain embodiments of the disclosure, said checking means can also comprise means for validating the vote according to at least one validation action performed by said elector and/or by an assessor.

If said validation means are intended for the electors, it can for example be a matter of pressing a key, an action on a touch-sensitive screen or the speaking of a keyword. If said validation means are for use by an assessor, they can require the provision of a password, a fingerprint or some other biometric information.

According to an exemplary embodiment of the disclosure, said device comprises at least one of the means belonging to the group comprising:
means for erasing voting information from a voting ballot;
means for returning a voting ballot;
means for secure storage of a voting ballot in a distinct area of said secure ballot box;
means for counting a failure, or a voting ballot not taken into account;
means for marking a voting ballot;
means for destroying a voting ballot,
used when said voting ballot and/or the voting conditions are considered invalid by said checking means.

In another complementary embodiment, said means used can differ according to the validity criteria not met. Thus, certain voting ballots can be returned by said device, for example if the elector does not belong to the electors expected by the device, and others kept in said distinct area of said ballot box, for example if the voting ballot is not readable.

In one example of the disclosure, said checking means issue at least one visible and/or audible signal, indicating the validity or invalidity of the voting ballot.

In certain particular embodiments, aimed at reassuring the electors, said checking means also comprise means of marking the validated voting ballots before their transfer to said secure ballot box.

According to an embodiment of the disclosure, said processing means can be diverse. In an exemplary embodiment of the disclosure, said processing means comprise means for storing and/or counting said item or items of voting information.

Said processing means can comprise in particular means for storing in a secure memory and/or means for transferring to at least one remote server at least one of the items of information belonging to the group comprising:
the nature of the election;
the district of said elector;
the polling station;
the polling date;
a reference of said writing means;
an approval of said writing means;
the name of said elector;
an identifier for said elector;
the content of the voting ballot of said elector;
the date and/or time of said voting ballot.

Said processing means can moreover comprise means of determining statistics, taking account for example of time stamp data associated with said voting information. These can be, for example, means of calculating and presenting voting statistics as a function of time in order to obtain in particular the pattern of change of the results of the vote as polling takes place.

Said processing means can also comprise means for transferring voting information and/or said statistics to at least one remote server.

According to an embodiment of the disclosure, said means for transferring to a remote server can be used during and/or after the voting, so as for example to have voting results in real time and/or to reconstruct a pattern of change of voting results as a function of time and/or to carry out remote verification of the results of the vote.

Thus, counting of the votes represented by the voting ballots can for example be carried out by both the device and at least one remote server for consolidation of the results.

In an exemplary embodiment of the disclosure, said reading means, said transfer means and said ballot box are at least partially transparent, so that an elector can continuously see his voting ballot until it is in said ballot box.

Thus, the device has the advantage of allowing a visual check by the people present. They can for example make sure that the voting ballot inserted into the device is indeed the voting ballot read and the one transferred into said ballot box.

According to an embodiment of the disclosure, said ballot box is equipped with locking means whereof opening is possible only according to at least one of the predetermined criteria belonging to the group comprising:
an end-of-polling date and time;
an end-of-appeal-period date and time;
authentication and/or identification information for at least one authorized person.

For example, the opening of said ballot box can be limited to authorized people. According to embodiment, said opening can be enabled following the supply of a password, a fingerprint or by means of a biometric identification method.

In another embodiment of the disclosure, said opening can also be refused before a time configured at ballot box level, such as the end-of-polling time for example.

According to an embodiment, said ballot box is implemented so as to guarantee the unchangeable nature of said voting ballots, in particular as a result of a physical or remote manipulation, at least until the times of appeal against the results have elapsed. In its manufacture, account will thus be taken of criteria such as the use of impact-resistant materials, electromagnetic isolation or sealing treatments for example.

Thus, in an exemplary embodiment of the disclosure, adapted to the use of voting ballots provided with an RFID chip for example, said ballot box has shielding means for protecting the voting ballots against an attempt at erasing, reading and/or writing data by electromagnetic wave emission.

For example, it can be made from a material forming an electromagnetic barrier and/or emit jamming signals.

The disclosure also concerns a method for secure electronic voting, using the device described previously, comprising the following steps:
insertion of a voting ballot into a reading device configured for reading the voting ballot and preventing withdrawal of said ballot;
checking validity of said voting ballot, issuing a signal for transferring said voting ballot to a ballot box, after the at least one item of voting information has been taken into account, when said voting ballot and/or voting conditions are considered valid;
processing with a processing device the at least one item of voting information read by said reading device; and
automatically transferring said voting ballot, after receipt of the signal confirming the at least one item of voting information has been taken into account and without human intervention, to the secure ballot box,
so as to allow double counting of said voting information, one using data read by said reading device , and another in a deferred manner, by reprocessing of the voting ballots kept in said ballot box.

Further, the disclosure concerns a computer program product downloadable from a communication network and/or recorded on a medium readable by computer and/or executable by a processor, characterized in that it comprises program code instructions for implementing the electronic voting method described previously.

### BRIEF DESCRIPTION OF THE DRAWINGS

Other characteristics and advantages will emerge more clearly from a reading of the following description of an exemplary embodiment, given by way of a simple illustrative and non-limiting example, and the accompanying drawings, amongst which:

FIG. 1 presents a functional block diagram of t one embodiment of the disclosure;

FIG. 6 details a use of the voting device according to an embodiment of the disclosure;

FIG. 7 presents a sectional view of the device presented in FIG. 6;

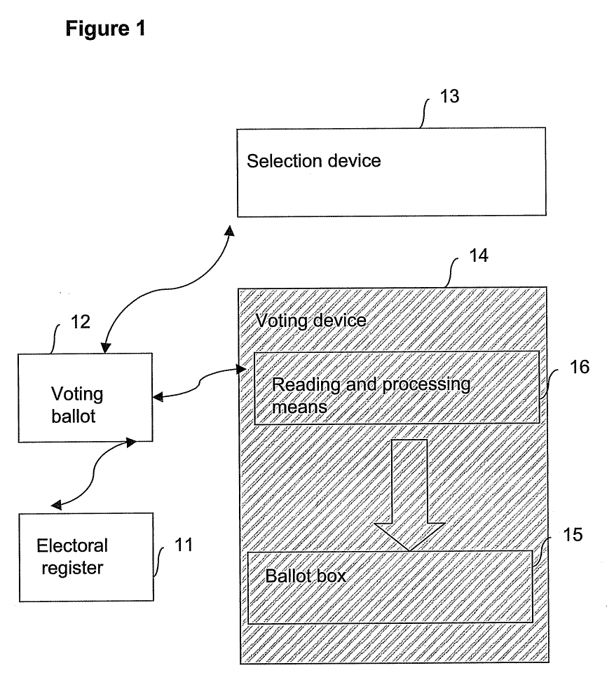

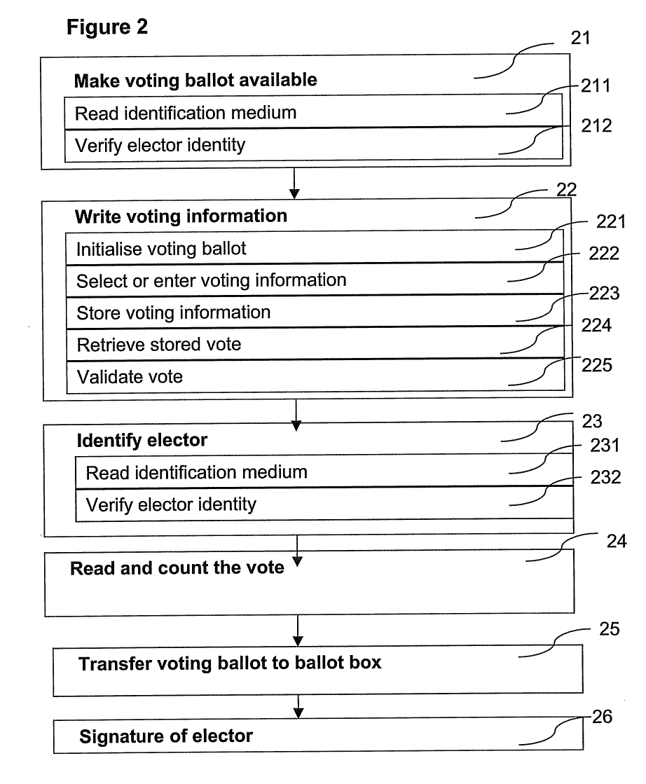

FIG. 2 illustrates the dynamic operation of an embodiment of the disclosure, based on the static block diagram of FIG. 1, as voting is taking place;

FIG. 3, based on the block diagram presented in FIG. 1, details the type of data stored in the electronic voting ballot;

FIG. 4 describes the dynamic operation of an embodiment of the disclosure during counting of the votes;

FIG. 5 presents another embodiment of the method of the disclosure for taking account of the vote.

### DETAILED DESCRIPTION OF ILLUSTRATIVE EMBODIMENTS

### 1. General Principle

An illustrative embodiment of the disclosure is based on the implementation of a novel voting device, combining a reader of electronic voting ballots, for example in the form of smart cards, and a secure ballot box, collecting the voting ballots after their reading and electronic processing (counting, storage, transfer and/or determination of statistics for example).

Thus, this provides the advantages of electronic voting, and in particular reduction of the risk of manual counting errors and immediate supply, at the end of polling (perhaps even in real time during polling, for certain applications where this would be desirable or useful), of the results of the vote. But the advantages of traditional voting are also retained, by allowing in particular a subsequent reprocessing of the voting ballots kept in the ballot box, for example in the event of dispute, or a fault occurring during polling.

Conversely, it is possible to carry out a conventional count, in public, of the contents of the ballot box. In this case, the information recorded previously can be used by way of a check.

This approach is novel, since electronic voting systems are generally based on conventional card readers, which return the card after reading it, generally so that it is then reused (after re-initialization). The approach of an embodiment of the disclosure therefore runs counter to the preconceptions of those skilled in the art on the one hand since it dictates a high number of electronic voting ballots (equal to the number of voters) and on the other hand since it assumes an adaptation of the card readers.

This is because these are generally designed to return the card after reading it (except, possibly, in fraud attempt cases, in the different field of bank cards, where a dispenser can “swallow” the card in the event of a detected problem). According to an embodiment of the disclosure on the other hand, the voting ballot is kept as a matter of course and directed to the ballot box, if the result of the reading is valid. On the other hand, if this result is not valid, the card can be given back, or stored in an area dedicated to that purpose, distinct from the ballot box.

The disclosure therefore makes it possible to propose a way of voting close to the traditional ways of voting, for an elector. For this, each elector is provided with a voting ballot (for example when he arrives at the polling station). This voting ballot is undifferentiated, or blank (as regards information relating to the voting choice, since it can comprise check information, identifying for example the vote concerned, the polling station, etc.). The elector conventionally slides his voting ballot into a ballot box, the reader acting as the slot of the ballot box, after configuring it (that is to say writing his vote on it).

This approach, although its aim is in particular to remain close to usual behavior, is not obvious to those skilled in the art. This is because all known electronic voting systems are on the contrary growing more distant from conventional methods, with security or efficiency objectives, which in the end make these systems complex and disconcerting for users.

### DESCRIPTION OF ONE PARTICULAR EMBODIMENT

Hereinafter there is considered an example of implementation of the disclosure adapted for use by a local authority, for example for a local, regional or national election. It should be understood that the same approach can be used, and if need be adapted, for any type of election (in a company, a school or university environment, etc.).

There is presented, in conjunction with FIG. 1, a particular embodiment of the method, in which the electoral register used 11 is an electronic electoral register. However, according to the embodiment of the method, a paper or electronic electoral register, or any other suitable means (for example electronic elector cards) can be used.

In this embodiment, the electronic voting ballot 12 handed to an elector consists of a microprocessor-based and/or memory-based card, capable of recording the vote (or votes, as applicable). A blank vote can be provided, if wished. On the other hand, the approach of an embodiment of the disclosure can make it possible to stop any null and void votes (if the voting ballot is not readable, it does not have to be counted, and/or does not have to be directed to the ballot box).

This particular embodiment of the disclosure makes provision for voting ballots 12 that can be reused among several elections (but not in the same election, since the voting ballots are kept in the ballot box after the vote), in order to take account of the economic impacts of the large scale elections for which it is designed.

In other embodiments, the voting ballots are on the contrary designed to be unable to be reused. For example, selection or the end of entry of an item of voting information consists of a non-reversible operation on the voting ballot 12, such as the activation of a fuse.

In this particular embodiment of the disclosure, a device 13 allows the selection of an item of voting information and the writing of said information on a voting ballot 12. This device is stand-alone, that is it is not connected to any computer system, in order to limit the risks of fraud. It can be installed, conventionally, in a polling booth.

The device 13 is provided with a screen that enables it to display the possible voting options. Its interface can also comprise a voice synthesis means and earphones for use by partially-sighted people. In this embodiment, the device 13 also comprises a means of validating an item of voting information. Here it is a validation key to be operated.

In a variant of this embodiment, the device can be equipped for example with a keypad or a touch-sensitive screen to allow the entry of at least one item of voting information.

The disclosure is furthermore based on a voting device 14 comprising means 16 for reading and processing, in particular counting, of the voting ballots 12 and a ballot box 15. It is designed so that any voting ballot introduced into the reading means 16 cannot be withdrawn, and is automatically (that is to say without human contact, or particular operation) directed to the ballot box 15, in which it is kept securely (the ballot box being locked so as to prevent the addition or withdrawal of voting ballots).

The device 14 can be provided with a human/machine interface enabling it on the one hand to issue messages to the users. These messages can be issued in many varied forms (for example, voice synthesis, screen display, printing) in order to take account of disabled people who may be present. On the other hand, the device described here also provides means for validation of the vote represented by the voting ballot, following reading of the voting ballot, by at least one assessor and/or by the elector. This can be, by way of example, a biometric sensor, another card reader, a keypad, etc.

Certain embodiments of the device 14 include additional means allowing it, after the end of polling, to read and retrieve the voting information from said voting ballots for the purpose of facilitating manual recounting of votes. The implementation of these additional means can include means for verifying the authorization of the operator and various retrieval means (for example, voice synthesis, screen display, printing, etc.) so as in particular to make recounting of the votes transparent and public in the event of disputes, even to a public comprising disabled people.

Periodic or routine transfers of the information read from the voting ballots to one or more secure servers can be implemented.

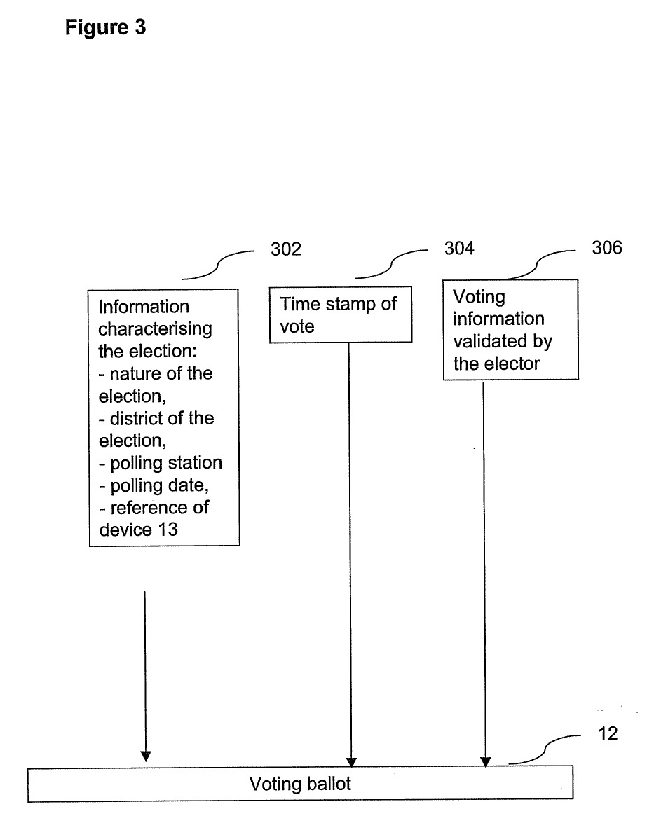

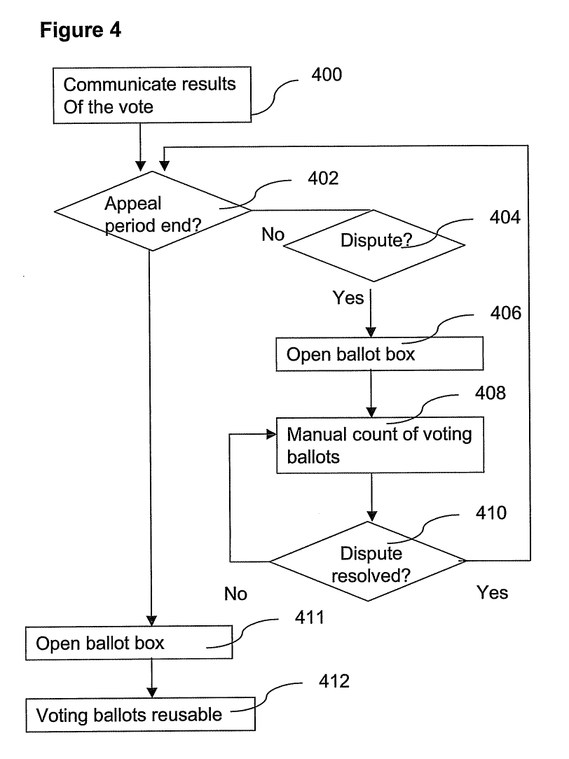

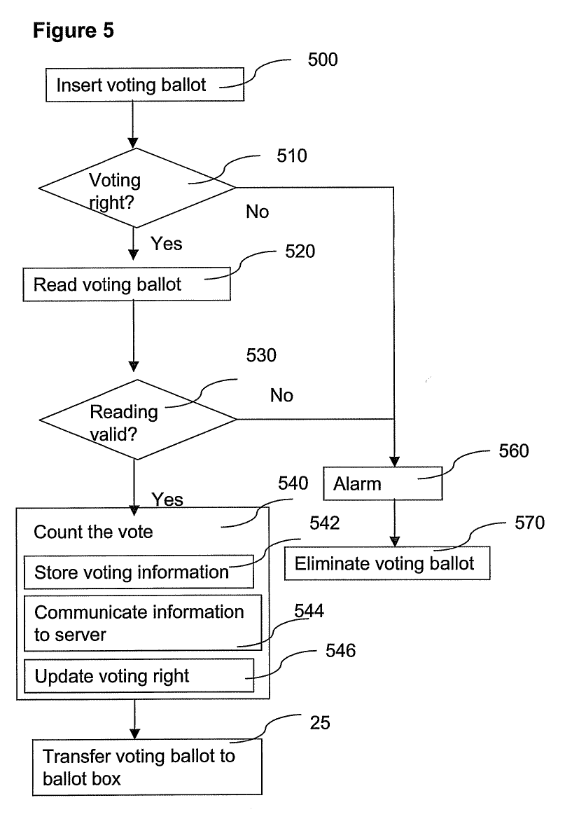

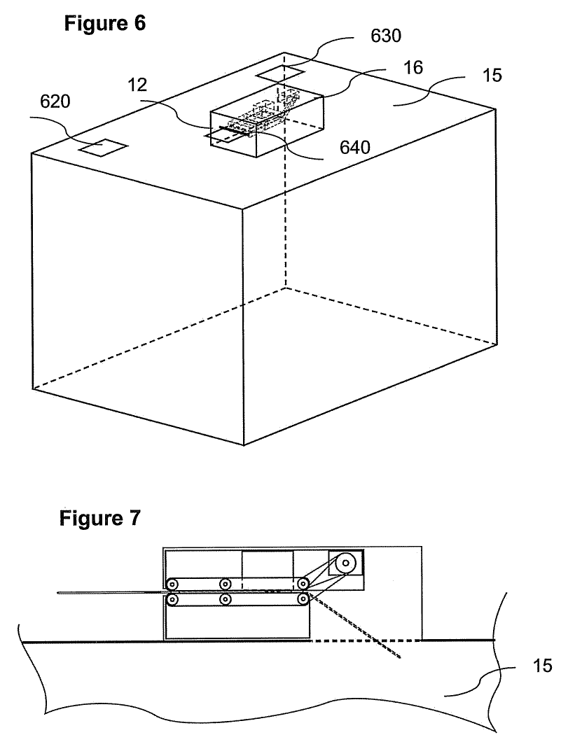

FIG. 6 illustrates one particular embodiment of the disclosure.

In this embodiment, the device 14 comprises means 16 for reading an electronic voting ballot 12. These reading means are provided with an insertion slot 640, in this way allowing the insertion of said voting ballot by an elector. The voting ballot 12, once inserted into said reading means 16, is inaccessible to any user. Specific means (valves, anti-intrusion elements, etc.) can be provided for that purpose. Provision can also be made for the assessor to have a command for returning a voting ballot, as long as he considers that the vote has not been carried out (for example until “has voted” has been indicated).

The device can also comprise checking means consisting, in the particular embodiment of the disclosure described here, on the one hand of means 620 for validation of the vote by the elector and on the other hand of means 630 for validation of the vote by an assessor. As indicated above, different validation means can be used. In the particular embodiment illustrated in FIG. 1, they are biometric sensors: the elector places a finger on the reader 620 and the assessor on the reader 630.

When the two readers confirm the identity of the two people, voting is possible, and the reading means read the voting information, and transmit it to processing means provided for that purpose. The device can be equipped with means for issuing the “has voted” message itself, and/or indicating by a visual signal that the vote has been taken into account.

The biometric means can be replaced by, and/or combined with, any suitable means for identifying and/or authenticating people, such as electronic identity or elector card readers, keypads for entering a confidential code, writing recognition means, etc.

According to a particular embodiment of the disclosure, the device can comprise, or be associated with, means for recording an electronic signature of the elector, in an elector register. Validation of the vote may dictate this parallel operation.

The device comprises means for transferring the electronic voting ballot 12 to the ballot box 15. For example, according to FIG. 7, it can be a drive mechanism adapted to slide the card 12 into the ballot box 15.

Furthermore, in order to avoid any dispute and allow the elector to check his vote, it is preferable that the ballot box (conventionally), but also the reading means and the transfer means, are at least partially transparent, so that the voting paper remains continuously visible, from its insertion into the reader until its transfer into the ballot box.

### 2. Example Implementations of the Device of the Disclosure

The device described above can in particular be used in an electronic voting method comprising the following steps:
making an undifferentiated electronic voting ballot comprising a memory available to an elector;
writing by said elector of at least one item of voting information, entered or selected from amongst at least two possible items of voting information, into the memory of said electronic voting ballot, by means of a writing device provided for that purpose;
immediate reading and counting, by said voting device, of said item or items of voting information written in the memory of said electronic voting ballot;
insertion of said electronic voting ballot into said ballot box of said device, with a view to a possible deferred check.

Thus, the elector has a voting ballot, which is specific to him for the election, which he handles like a conventional voting paper, and which will be kept in a ballot box. Analysis of the contents of this ballot box can allow a subsequent verification count, and/or rereading of the votes, if necessary.

However, before being transferred to the ballot box (or simultaneously in certain embodiments), the voting ballot is read and counted secretly, which makes it possible to provide the result of the election as soon as the voting period ends.

When the voting ballot is handed to the elector, it is undifferentiated, that is to say it comprises no information relating to the elector (it is not an identity card or an elector card, but indeed a voting ballot, on which the elector is going to write his vote, before sliding it into the ballot box). It is moreover individual, that is to say intended to contain the information of a single elector during a poll.

In certain embodiments, the method can also comprise, in addition to the steps mentioned previously, a step of communicating the results of the poll associated with a voting device to a remote server in order to allow centralization of the results of the poll.

In preferential embodiments, the method endeavors to retain the traditional public or secret nature of the voting steps in order to not disconcert the users: for example, the step of making said voting ballot available to an elector and the step of voting using said device can be carried out publicly whilst the step of writing by said elector of at least one item of voting information will remain secret.

Similarly, in advantageous embodiments, the method makes provision that, although immediate, the counting of the votes is not communicated in any way before the end of voting.

One of the advantages of the device and method of the disclosure is thus to allow an immediate count of the votes as soon as polling ends, whilst providing a possibility of manual recounting of the votes in the event of disputes by means of a further reading of the stream of said electronic voting ballots.

Said step of writing by said elector of said item or items of voting information comprises the following substeps:
a substep of selection or entry by said elector of said item or items of voting information;
a substep of storing said voting information in said electronic voting ballot;
a substep of retrieving said voting information, for checking by said elector of said item or items of voting information stored in said electronic voting ballot;
a substep of irreversible validation by said elector of said item or items of voting information.

In particular embodiments, said step of writing by said elector of said item or items of voting information can in addition include a substep of initialization of said electronic voting ballot.

In this case, said initialization substep can for example consist first of all of erasing (and/or checking) the data potentially present on the voting ballot. This provides the advantage of safeguarding the vote with regard to voting ballots fraudulently pre-filled in and allows reuse of voting ballots for several separate elections.

According to the embodiment, said initialization substep can also comprise storing in said electronic voting ballot at least one characteristic of the election belonging to the group comprising:
the nature of the election;
the district of the elector;
the polling station;
the polling date;
a reference of said writing device.

In certain particular embodiments, said step of writing said item or items of voting information can also comprise a substep of storing an item of time stamp data for the vote, such as the date and/or time of the vote, in said voting ballot.

The method can furthermore provide for a step of identification of an elector by means of an electronic electoral register, comprising at least one of the following substeps:
reading of a medium for identifying said elector, by means of an electronic reader;
signing of said elector by means of a touch-sensitive screen and/or a biometric sensor.

The way in which this verification of the identity of the elector is carried out can depend on the embodiment.

The disclosure also concerns means for writing at least one item of voting information on an electronic voting ballot comprising:
means for configuring at least two voting options;
means for receiving an undifferentiated electronic voting ballot;
means for presenting said voting options to an elector;
means for selection or entry of one of said options by said elector;
means for recording at least one item of voting information on said voting ballot;
means for checking by said elector of said item or items of recorded voting information.

Said voting options configured in said voting ballot can include at least one of the items belonging to the group comprising:
candidates;
lists of candidates;
a response to a referendum;
the selection or the indication of a blank vote.

In certain embodiments, the checking means made available to said elector by said writing means also enable him to verify and then irreversibly validate his vote. In other embodiments, the reader can itself modify a characteristic (physical, electrical, etc.) of the voting ballot by way of validation. For example, in an embodiment in which said voting ballot is not reusable, provision can be made for said elector to validate his choice by detaching a specific part of said voting ballot.

FIG. 2 illustrates an example of dynamic operation of the disclosure.

A first step 21 consists of making an undifferentiated voting ballot available to an elector. In this embodiment, this step takes place publicly, that is to say in the presence of one or more people.

This step comprises first of all a substep 211 of reading the medium for identifying the elector. According to the embodiment, this medium can consist of a paper electoral card or one in electronic form. The electoral card can be a stiff paper card comprising a barcode which enables it to be read by means of an electronic reader. Coupled with an electronic electoral register (the electoral register 11 in FIG. 1), this embodiment provides the advantage of making it possible to find an elector in the electoral register quickly. These operations can also be performed electronically, in particular in a manner coupled with the voting device.

In this embodiment, the method next provides for a substep 212 of verifying the identity of the elector. On the one hand, the information read from the electoral card is compared with the electoral register in order to verify the registration of the elector in the electoral register of the polling station and obtain the expected identity of the elector. On the other hand, a check on the identity of the holder of the card is performed. According to the embodiment, this check can be done by provision of an identity document or by a comparison with an anthropometric or biometric print recorded for example at electoral register level.

This substep ends with the supply of an electronic voting ballot to the elector. In the embodiment described, it is an electronic card comprising a microprocessor and/or a memory.

According to an embodiment of the disclosure, the method then implements a second step 22 of writing an item of voting information on said voting ballot.

This step, which is generally carried out in the polling booth, is divided into several substeps. In this particular embodiment, the first substep consists of initialization 221 of the voting ballot. This is because, as the voting ballots are here reusable for another election and with a concern for limiting the risks of fraud, provision is made to first of all erase any data potentially present on the voting ballot, or at the very least allow the contents of the voting ballot to be checked.

Moreover, as illustrated in FIG. 3, information 302 characterizing the election, for example the nature of the election, the district and polling station of the elector, and a reference of the device 13, is added to the voting ballot 12. This information can also include a time stamp of the vote 304 (date and/or time of the vote). These data can be used for statistical purposes or enable subsequent checks if necessary. According to another embodiment, they can have been written beforehand on all the voting ballots.

The method next provides a substep 222 for entry or selection of an item of voting information by the elector from amongst the voting options presented to him.

The choice of a voting option by the elector is followed by a substep 223 of storing the entered or selected voting information at electronic voting ballot level. FIG. 3 also illustrates the storing 306 of the voting information validated by the elector at the level of the memory of the voting ballot 12.

A substep 224 of retrieving the recorded vote, for example on a screen, next enables the elector to verify that the vote written on said voting ballot is indeed the one he chose.

A last substep 225 of validating the vote closes the phase of writing on the voting ballot and causes the return of said voting ballot to the elector. In this embodiment, this validation is performed by pressing a validation key on the device 13. In other embodiments, it can for example be voice recognition of a keyword by means of the device 13. Different validation methods can be implemented outside the device 13, for example by means of an action of said elector on said voting ballot.

In the case where several votes are to be made simultaneously (elections relating to separate authorities, choices concerning several distinct aspects, etc.), it is possible to write several items of voting information successively on the same voting ballot.

In the embodiment illustrated, the following step is a public step 23 of identifying the elector. This step is similar to the step 21 (but can be based on different means) and comprises a substep 231 of reading the medium for identifying the elector, similar to the step 211 described above and making it possible to search for the elector in the electoral register, and a substep 232 of verifying his identity. This on the other hand ends in validating the right of the elector to vote, that is to say enabling the move to the following step 24 of reading and counting the vote.

According to the embodiment of the disclosure, the step 23 can take place before or after insertion of the voting ballot into the voting device 14. In the latter case, as illustrated in FIG. 6, the device 14 can be provided with the necessary checking means and in particular, if the voting right is verified manually, a means 630 of validation by an assessor, which can be either a means identifying the assessor, or a simple control (button, lever, etc.).

In the embodiment described here, the reading and counting step 24 takes place publicly. The elector inserts his voting ballot 12 into the device 14. In this embodiment, pressing a biometric sensor 630 for validation by the assessor causes the reading of the vote and its immediate counting. A message indicates to the elector that his vote has actually been taken into account.

According to the embodiment, the reading of the voting ballot can comprise the reading of at least one item of information present on said voting ballot other than the voting information. This information, as illustrated in FIG. 3, can make it possible in particular to perform an additional check on the validity of the voting ballots. In the event of incorrect reading of the voting ballot or doubt on its validity or multiple insertions, the vote is not counted.

The step 25 of transfer of the voting ballot into the ballot box follows the vote being taken into account.

The last step is a step 26 of signing of the elector. The way in which the signature of the elector is affixed depends on the embodiment. In a particular embodiment, close to traditional voting, the elector can for example sign an electronic electoral register by means of a special pencil and a touch-sensitive screen. In another embodiment, he can also affix his fingerprint on a touch-sensitive screen. Another implementation possibility would consist of the use of another biometric means.

In a particular embodiment, the means allowing the signing of the elector can be implemented by the voting device 14, for example by means of the biometric sensor 620 illustrated in FIG. 6. This operation can then take place simultaneously with the voting Oust as, if applicable, the signing step).

The method has the advantage of allowing a very fast, perhaps even instantaneous, counting of the votes at the end of polling. If transfers were made to a server, this also has available, almost instantaneously, the result of the voting from all equipped polling stations.

FIG. 4 describes one embodiment of the counting of the votes.

According to the embodiment of the method, communication 400 of the results of the electronic vote can be carried out in various ways by the vote counting device. It can for example be at least one of the following means: printing, voice synthesis, a screen display, communication to a remote site, availability on an Internet site, etc.

The voting ballots remain kept in the ballot box, for example awaiting the end of the appeal period 402.

In the event of a dispute 404, it is necessary to open 406 the ballot box. In the particular embodiment described here, this is possible only after the end-of-polling time and in addition requires the entry of a secret code.

The method in this case provides for a manual counting of the voting ballots 408 by reading the stored voting information.

Once the dispute has been resolved 410 and the appeal period has expired, the voting ballots are considered capable of being reused 412.

FIG. 5 illustrates another method for taking the vote into account, based on the voting device of the disclosure.

In this particular embodiment, the method provides for a first step 500 of inserting the voting ballot into the voting device, followed by a step 510 of verifying the right to vote of the elector. In the embodiment illustrated here, this is a matter of verifying the identity of the elector (like in step 23, FIG. 2), followed by verifying that the vote of said elector has not already been counted for this poll.

Where the elector is actually entitled to vote, this step is followed by a step 520 of reading the electronic voting ballot and in particular the voting information it contains.

Next comes a step 530 of verifying the validity of the voting ballot. For example, a voting ballot is considered valid if it is readable and contains the expected polling date.

Where the voting ballot is considered valid, this step is followed by a step 540 of counting the vote. This step comprises several substeps:
a substep 542 of storing the voting information;
a substep 544 of communicating the voting information to a remote server, thus enabling, for example, the server in its turn to count the voting information;
a substep 546 of updating the voting rights of the elector, in order that he can no longer present a voting ballot. This updating of the voting right is here carried out locally by the device. In another embodiment, it can be carried out by a remote server, to which the device communicates, for example, the identity of the elector.

Finally, the voting ballot is automatically transferred (25) to the associated ballot box 15.

When it is detected (step 510) that a voting ballot does not correspond to an elector having a voting right or when in step 530 a voting ballot is considered non-valid, an alarm 560 is provided for, in order to signal the rejection of the voting ballot.

According to the embodiment, this can be a local indication (visual or audible for example) and/or an indication to a remote server, in order for example to inform an authorized person of any anomaly while polling is taking place.

This step is followed by a step of elimination 570 of the voting ballot. According to the embodiment, this can be destruction, erasing or marking of the voting ballot, keeping in a subsidiary ballot box or rejection.

One exemplary aspect of the present disclosure overcomes a drawback of the prior art by proposing a technique providing at least some of the advantages of voting machines, in particular in terms of speed and reliability, whilst observing certain usual practices.

An exemplary aspect of the disclosure provides a technique making it possible to reassure the electors, and facilitate voting and checking operations for them.

An exemplary aspect of the disclosure safeguards and increases the reliability of the voting and checking operations, if applicable.

Yet another exemplary aspect of the disclosure speeds up the counting of the votes and, for at least certain applications, provides various information, in particular statistics, on the voting and the way it is progressing. For example, if a time stamp is associated with the voting information, it is possible to monitor the pattern of change of the voting as a function of time.

Another exemplary aspect of the disclosure proposes a method allowing savings of paper, with sustainable development in mind.

Although the present disclosure has been described with reference to one or more examples, workers skilled in the art will recognize that changes may be made in form and detail without departing from the scope of the disclosure and/or the appended claims.

What is claimed is:

1. A secure electronic voting device, comprising:
means for reading electronic voting ballots carrying at least one item of voting information previously written by an elector using an appropriate writing device;
means for inserting a voting ballot into said reading means, cooperating with means for preventing withdrawal of said ballot;
means for checking validity of said voting ballot, issuing a signal for transferring said voting ballot to a secure ballot box, after the at least one item of voting information has been taken into account, when at least one of said voting ballot or voting conditions are considered valid;
means for processing the at least one item of voting information read by said reading means; and
means for automatically transferring said voting ballot, after receipt of said signal confirming the voting ballot has been taken into account and without human intervention, to the secure ballot box, so as to allow double counting of said item of voting information, one using the item of voting information read by said reading means, and another in a deferred manner, by reprocessing the voting ballots kept in said secure ballot box.

2. The secure electronic voting device according to claim 1, wherein said checking means take account of at least one item of information for identification and/or authentication of an elector and/or at least one assessor responsible for said vote.

3. The secure electronic voting device according to claim 2, wherein said checking means comprise at least one of the items belonging to the group comprising:
means for obtaining at least one item of biometric information;
means for reading at least one identification and/or authentication data medium;
a keypad for entering an identification and/or authentication code;
means for recording and/or voice recognition of at least one keyword;
means for recording and/or recognizing a handwritten signature.

4. The secure electronic voting device according to claim 1, where said checking means verify validity of the at least one item of voting information present on said voting ballot, with respect to at least one predefined validity criterion.

5. The secure electronic voting device according to claim 1, where in the device comprises at least one of the item belonging to the group comprising:
means for erasing voting information from a voting ballot;
means for returning a voting ballot;
means for secure storage of a voting ballot in a distinct area of said secure ballot box;
means for counting a failure, or a voting ballot not taken into account;
means for marking a voting ballot;
means for destroying a voting ballot,
wherein the device uses the item when said voting ballot and/or the voting conditions are considered invalid by said checking means.

6. The secure electronic voting device according to claim 1, wherein said checking means issue at least one visible and/or audible signal, indicating validity or invalidity of the voting ballot.

7. The secure electronic voting device according to claim 1, wherein said processing means comprise means for storing and/or counting said at least one item of voting information.

8. The secure electronic voting device according to claim 1, wherein said processing means comprise means for determining statistics, taking account of time stamp data associated with said voting information.

9. The secure electronic voting device according to claim 8, wherein said processing means comprise means for transferring voting information and/or said statistics to at least one remote server.

10. The secure electronic voting device according to claim 1, wherein said reading means, said transferring means and said ballot box are at least partially transparent, so that an elector can continuously see his voting ballot until the voting ballot is in said ballot box.

11. The secure electronic voting device according to claim 1, wherein said ballot box is equipped with locking means whereof opening is possible only according to at least one of the predetermined criteria belonging to the group comprising:
an end-of-polling date and time;
an end-of-appeal-period date and time;
authentication and/or identification information for at least one authorized person.

12. The secure electronic voting device according to claim 1, wherein said ballot box has shielding means for protecting the voting ballots against an attempt at erasing, reading and/or writing data by electromagnetic wave emission.

13. A method for secure electronic voting, the method comprising the following steps:
insertion of a voting ballot into a reading device configured for reading the voting ballot and preventing withdrawal of said ballot;
checking validity of said voting ballot, issuing a signal for transferring said voting ballot to a secure ballot box, after the at least one item of voting information has been taken into account, when said voting ballot and/or voting conditions are considered valid;
processing with a processing device the at least one item of voting information read by said reading device; and
automatically transferring said voting ballot, after receipt of said signal confirming the at least one item of voting information has been taken into account and without human intervention, to the secure ballot box, so as to allow double counting of said voting information, one using data read by said reading device, and another in a deferred manner, by reprocessing of the voting ballots kept in said ballot box.

14. A computer program product recorded on a medium readable by computer and comprising program code instructions for implementing a method for secure electronic voting, the method comprising the following steps:
inserting a voting ballot into a reading device configured for reading the voting ballot and preventing withdrawal of said ballot;
checking validity of a voting ballot, issuing a signal for transferring said voting ballot to a ballot box, after the at least one item of voting information has been taken into account, when said voting ballot and/or voting conditions are considered valid;
processing with a processing device the at least one item of voting information read by said reading device; and
automatically transferring said voting ballot, after receipt of the signal confirming the at least one item of voting information has been taken into account and without human intervention, to a secure ballot box, so as to allow double counting of said voting information, one using data read by said reading device, and another in a deferred manner, by reprocessing of the voting ballots kept in said ballot box.
